(19) United States
(12) Patent Application Publication
(10) Pub. No.: US 2008/0117058 A1
(43) Pub. Date: May 22, 2008

(54) CONTAINER SECURITY SEAL WITH DESTRUCTIBLE RFID TAG

(75) Inventor: Robert R. Oberle, Macungie, PA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY INC., QUAKERTOWN, PA (US)

(21) Appl. No.: 11/853,697

(22) Filed: Sep. 11, 2007

Related U.S. Application Data
(60) Provisional application No. 60/866,719, filed on Nov. 21, 2006.

(51) Int. Cl. G08B 13/14

(52) U.S. Cl. 340/572.8

(57) ABSTRACT

An RFID securitization piece can comprise a housing. An RFID tag in the housing can include an RFID chip and RFID antenna. The RFID securitization piece is attachable to an object such that when the RFID securitization piece is removed from the object the RFID tag is damaged. RFID interrogations will then indicate that the RFID securitization piece has been removed from the object.

### CLAIM OF PRIORITY

This application claims priority to U.S. Provisional Application No. 60/866,719 entitled “Container Security Seal with Destructible RFID Tag” filed Nov. 21, 2006, which is incorporated herein by reference. [Atty. Docket No. RCDT-01014US0]

### BACKGROUND OF INVENTION

Cargo containers are routinely locked and sealed to maintain the integrity of the cargo container therein. Typically the seal is installed on one of several hasps which secure the turn-bar closure latches on the doors of the container. The seal may take the form of a physical barrier such as a padlock or tamper evident tag, or may be electronic. The electronic seal is generally intended and configured to identify a breach of the container rather than to be physical barrier, through there is not intrinsic reason that both physical and electronic barriers to access cannot be combined in the same device. The electronic functionality can be easily interpretable and tamper evident if not tamper proof.

### BRIEF DESCRIPTION OF THE DRAWINGS

FIG. 1 shows an exemplary RFID securitization piece.

FIG. 2 shows a pin that can attach to the RFID securitization piece of FIG. 1.

FIGS. 3A-3B shows the operation of one embodiment.

### DETAILED DESCRIPTION

Radio Frequency Identification (RFID) tags can utilize a small transponder that consists generally of a single small chip, a suitably configured antenna and appropriate packaging. The antenna can be a 2 dimensional circuit deposited on a suitably chosen flexible or rigid substrate. Examples of flexible substrates are Polyethylene Terephthalate (PET), polyester, Acrylonitrile Butadiene Styrene (ABS) and polyimide. Examples of rigid substrates are Flame Resistance 4 (FR4) epoxy laminate, polycarbonate sheets and glass. The final packaged devise may be used in a variety of formats, for self adhesive labels, injection molded parts of laminated structures. The transponder is often referred to as an RFID tag and the electronic portion (antenna with an appropriately bonded chip on a substrate) as an inlay. The transponder can communicate with a sending unit (typically referred to as a reader) by a radio frequency protocol in response to a query from the reader. The RFID tag is typically positioned such that conductive surfaces do not shield communications between an RFID tags and RFID readers. The description given herein is generic and is not intended to be comprehensive or limiting as to materials of construction or configuration.

RFID technology offers a platform which possesses many features that can be used to fabricate a suitable container seal. The electronic integrity is contained in the individual identity of the RFID chip which is permanently set during the chip fabrication process and cannot be changed. The ease of reading comes from the non-contract node of interrogation which is common to RFID. The non-line-of-sight communication allows identification from a variety of orientations and greater consistency that optically based reader techniques. These two features give RFID technology significant advantages over labels, wire seals, or other traditional print media seals which are widely used. Printed media is fairly easily reproduced using commonly available techniques and printed media is easily damaged by the handling and outdoor exposure common in shipping and transportation environments.

An effective tamper evident electronic seal can be easily installed, preferably without tools, and without surface preparation of the door; and designed to fit standard latches utilized in the industry. In addition, the seal installation can be done and the seal required to function in inclement weather (rain, snow, high heat and humidity), and the seal can leave no residue on the container which would require subsequent cleaning or maintenance to the container itself. For these reasons RFID enabled labels with self adhesive labels may not be a particularly good solution since the water, grease and dirt can hinder the efficacy of the adhesive upon installation. Lastly, the container seal should be cost effective. The device intended to be single use, such that it is irrevocably destroyed with removed, thus the device should be inexpensive enough to have a suitable return on investment (ROI) associated with a single use.

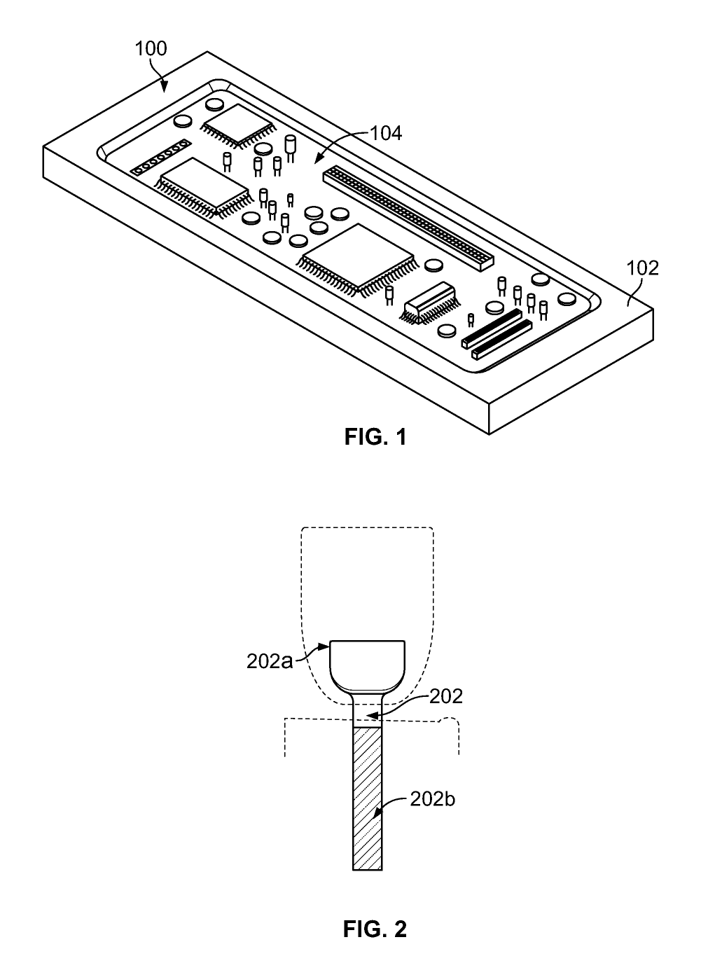

FIG. 1 shows an exemplary RFID securitization piece 100. The RFID securitization piece 100 can comprise a housing 102 made of plastic or any other suitable material. A RFID tag 104 in the housing 120 can include an RFID chip and RFID antenna. The RFID securitization piece 100 can be attachable to an object such that when the RFID securitization piece 100 is removed from the object, the RFID tag is damaged and the RFID tag no longer operates indicating that the RFID securitization piece has been removed from the object.

In one embodiment when the RFID securitization piece and the object move with respect to one another, the RFID tag can be damaged.

Since the RFID tag has been destroyed it can be difficult if not impossible to re-seal a protected container to hide that it has been previously opened. This can indicate potential thefts and the like.

The RFID tag can have an adhesive that contacts the object. This adhesive can be a glue form that can be applied from a tub or adhesive strip. Alternately, the RFID tag can be attached to the object with two sided tape.

As shown in FIG. 2, the securitization piece can be shaped to attach to a pin 202. In one embodiment, the pin 202 can have a head 202a to be held in a hasp and a flat section attached 202b to the RFID tag of the securitization piece.

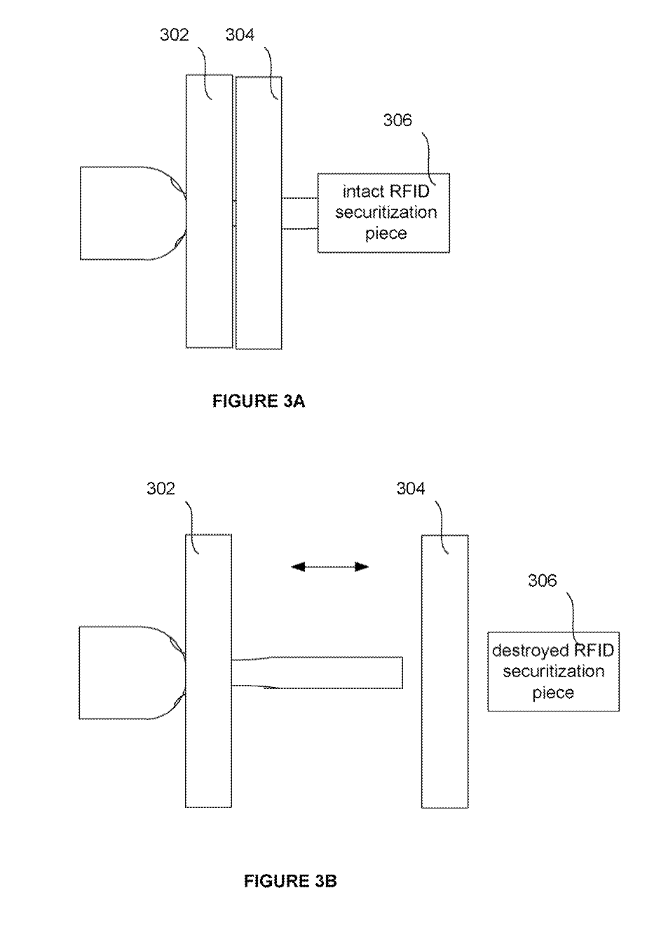

FIGS. 3A-3B show an example in operation. As elements 302 and 304 move apart, the RFID tag of the securitization piece 306 is destroyed. The elements 302 and 304 can be part of a hasp on a shipping container or the like.

Embodiments can provide an effective tamper evident seal which meets the technical and economic constraints outlined above. The seal can be a two piece construction one part of which is inserted through the locking hole in the hasp, the second piece can be secured to the first once it has been inserted by means of an adhesive closure, potentially combined with a mechanical fixture. The adhesive portion can overly the antenna and chip of the RFID inlay. The strength of the adhesive can exceed the adhesion of the antenna to the substrate and the cohesion of the chip/antenna bond. Thus any attempt to separate the two pieces can result in disruption of the RFID circuit. The two pieces may be individually molded and may take a variety of configurations tailored to specific circumstances and demands of individual users. A common feature can be that the seal once assembled can not fit backward through the lock hasp without separating the two pieces of breaking the mounting mechanism.

A drawing of one proposed configuration illustrating the essential features of the tag is shown in FIGS. 1 and 2. In this example, the insertion piece consists of a long flat tag, connected to a fitted round insertion end. This end is designed to seat securely in the hole in the hasp. The securing piece of the tag can be essentially a flat piece with a shallow depression into which is applied an RFID inlay. The inlay can be bonded into the depression by any of various means such as, using glue, pressure sensitive adhesive, ultrasonic welding or other suitable attachment methodology. The hollow in the securitization piece can be configured such that the surface of the inlay is flush with the surface of the hollow. The surface of the inlay and potentially that of the securitization piece (though not necessarily) can be coated with a pressure sensitive adhesive. The adhesive can be chosen such that the adhesion of the securitization piece to the insertion piece is greater than the adhesion of the electronic portion on the inlay to the substrate of the securitization piece. This feature can afford the tamper evidency. The exact conformation of the seal and the materials of construction can be tailored to fit the needs of the individual application, affording the seal more or less physical security as well as tamper evidency as required. The choice of adhesive can also be a major factor. These two parameters can be manipulated to afford more or less security for the application.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. An RFID securitization piece comprising:
a housing;
an RFID tag in the housing, the RFID tag including an RFID chip and RFID antenna, wherein the RFID securitization piece is attachable to an object such that when the RFID securitization piece is removed from the object the RFID tag is damaged and no longer operates indicating that the RFID securitization piece has been removed from the object.

2. The RFID securitization piece of claim 1, wherein the RFID tag has an adhesive that contacts the object.

3. The RFID securitization piece of claim 1, wherein the RFID tag is attached to the object with two sided tape.

4. The RFID securitization piece of claim 1, wherein the securitization device is shaped to attach to a pin.

5. An assembly including the RFID securitization devise of claim 1, further comprising the object.

6. The assembly of claim 5, wherein the object is a pin.

7. The assembly of claim 6, wherein the pin has a head to be held in a hasp.

8. The assembly of claim 6, wherein the pin includes a flat section attached to the RFID tag of the securitization piece.

9. An assembly comprising an object; and
A securitization device including,
a housing;
an RFID tag in the housing, the RFID tag including an RFID chip and RFID antenna, wherein the RFID securitization piece is attached to the object such that when the RFID securitization piece is removed from the object the RFID tag is damaged and tag no longer operates indicating that the RFID securitization piece is removed from the object.

10. The assembly of claim 9, wherein the RFID tag has an adhesive that contacts the object.

11. The assembly of claim 9, wherein the RFID tag is attached to the object with two sided tape.

12. The assembly device of claim 11, wherein the object is a pin.

13. The assembly of claim 12, wherein the pin has a head to be held in a hasp.

14. The assembly of claim 12, wherein the pin includes a flat section attached to the RFID tag of the securitization piece.

15. An RFID securitization piece comprising:
a housing;
an RFID tag in the housing, the RFID tag including an RFID chip and RFID antenna, wherein the RFID securitization piece is attachable to an object such that when the RFID securitization piece and object move with respect to one another, the RFID tag of the securitization piece is damaged such that RFID interrogations indicate that the movement between the object and RFID securitization piece has occurred.

16. The RFID securitization piece of claim 15, wherein the RFID tag has an adhesive that contacts the object.

17. The RFID securitization piece of claim 15, wherein the RFID tag is attached to the object with two sided tape.

18. The RFID securitization piece of claim 15, wherein the securitization device is shaped to attach to a pin.

19. An assembly including the RFID securitization devise of claim 15, further comprising the object.

20. The assembly of claim 19, wherein the object is a pin.

21. The assembly of claim 20, wherein the pin has a head to be held in a hasp.

22. The assembly of claim 20, wherein the pin includes a flat section attached to the RFID tag of the securitization piece.
